(19) United States
(12) Patent Application Publication
(10) Pub. No.: US 2026/0237813 A1
(43) Pub. Date: Aug. 13, 2026

(54) FIRE-RETARDANT ASSEMBLY AND BATTERY ASSEMBLY INCLUDING THE SAME

(71) Applicant: SK On Co., Ltd., Seoul (KR)

(72) Inventors: Won Gab HWANG, Daejeon (KR); Chae Won NA, Daejeon (KR); Gang U LEE, Daejeon (KR); Kyu Hyun HAN, Daejeon (KR)

(21) Appl. No.: 19/533,315

(22) Filed: Feb. 9, 2026

(30) Foreign Application Priority Data
Feb. 10, 2025 (KR) 10-2025-0016511

(51) Int. Cl. H01M 50/24; H01M 50/211; H01M 50/503; H01M 50/505

(52) U.S. Cl. CPC H01M 50/24; H01M 50/211; H01M 50/503; H01M 50/505

(57) ABSTRACT

The present disclosure relates to a fire-retardant assembly including a fire-retardant member including a fire-retardant material, and an exterior configured to accommodate the fire-retardant member therein. The exterior includes a housing part having a pillar shape, and a guide part disposed on a portion of one side surface of the housing part to have a shape protruding in a direction away from the housing part.

The present application claims priority under 35 U.S.C. § 119(a) to Korean patent application number 10-2025-0016511 filed on Feb. 10, 2025, in the Ministry of Intellectual Property, the entire disclosure of which is incorporated by reference herein.

### BACKGROUND OF THE INVENTION

### Field

The present disclosure relates to a fire-retardant assembly inserted into a battery assembly and a battery assembly including the same. More particularly, the present disclosure relates to a fire-retardant assembly capable of improving thermal stability of a battery assembly, and a battery assembly including the same.

### Description of the Related Art

Recently, due to fire or explosion accidents that have occurred during the use of lithium secondary batteries, there has been an increasing social concern regarding safety in use of the batteries. Based on such the societal concern, one of the main development subjects for lithium secondary batteries in recent years is to eliminate insecurity issues such as the fire and explosion caused by thermal runaway of battery cells.

Particularly, in a battery module/pack, there is an empty space other than the battery cells that serve as a source of energy. In the event of fire caused by external impacts or problems of the battery cell, flame may spread to adjacent cells through the empty space, resulting in greater damage due to the fire. Since this fire risk is the biggest obstacle in the electric vehicle markets, a method for reducing the spread of fire are continuously being researched.

### SUMMARY OF THE INVENTION

First, an object of the present disclosure is to improve heat resistance or fire resistance, thereby enhancing stability of a battery assembly.

Second, another object of the present disclosure is to prevent or mitigate a high-temperature gas generated from a battery cell in which thermal runaway occurs in a battery assembly, e.g., one or more battery cells provided inside the battery assembly from leaking toward a tab of the battery cell.

Third, further another object of the present disclosure is to add a guide shape instead of a chamfer shape to an existing fire-retardant assembly.

Fourth, further another object of the present disclosure is to easily dispose the fire-retardant assembly when a battery assembly is assembled.

Fifth, further another object of the present disclosure is to improve a filling rate of a fire-retardant assembly.

Sixth, further another object of the present disclosure is to improve assemblability of a battery assembly.

The battery assembly according to the present disclosure may be widely applied in fields of the electric vehicles, the battery charging stations, the energy storage systems (ESSs), and other green technologies such as the photovoltaics and the wind power utilizing batteries. In addition, the battery assembly according to the present disclosure may be used in eco- friendly mobility including the electric vehicles and the hybrid vehicles, in order to prevent the climate change by suppressing the air pollution and an emission of a greenhouse gas.

A fire-retardant assembly according to the present disclosure includes: a fire-retardant member including a fire-retardant material; and an exterior configured to accommodate the fire-retardant member therein, wherein the exterior includes: a housing part having a pillar shape; and a guide part disposed on a portion of one side surface of the housing part to have a shape protruding from the housing part.

The guide part may extend in a direction from one end to the other end of the housing part.

The exterior may include an end configured to cover at least one opened end of the housing part and having one surface having a planar shape.

The exterior may include: a first end provided as one end of both opened ends of the housing part and coupled to an upper side of the housing part to cover the one end; and a second end provided as the other end of both the opened ends of the housing part and coupled to a lower side of the housing part to cover the other end, wherein the first and second ends may be opposite to each other.

The guide part may be integrated with the housing part.

The fire-retardant member may include a plurality of fire-retardant particles.

The plurality of fire-retardant particles may be provided in a granular form.

A battery assembly according to the present disclosure includes: a plurality of battery cells; an accommodation case configured to accommodate the plurality of battery cells; an insertion space defined between the plurality of battery cells and the accommodation case; and a fire-retardant assembly disposed in the insertion space, wherein the fire-retardant assembly includes: a fire-retardant member including a fire-retardant material; and an exterior configured to accommodate the fire-retardant member therein, wherein the exterior includes: a housing part having a pillar shape extending in a height direction of the accommodation case; and a guide part disposed on a portion of one side surface of the housing part to have a shape protruding from the housing part.

The guide part may extend in a direction from one end to the other end of the housing part.

The exterior may include an end configured to cover at least one opened end of the housing part and having one surface having a planar shape.

The exterior may include: a first end provided as one end of both opened ends of the housing part and coupled to an upper side of the housing part to cover the one end; and a second end provided as the other end of both the opened ends of the housing part and coupled to a lower side of the housing part to cover the other end, wherein the first and second ends may be opposite to each other.

One surface of the second end may be provided in a planar shape disposed on a bottom surface of the accommodation case.

The guide part may be integrated with the housing part.

The battery assembly may further include a busbar assembly configured to support the plurality of battery cells and electrically connected to the plurality of battery cells, wherein the guide part may be supported by the busbar assembly.

The busbar assembly may include: a busbar electrically connected to the plurality of battery cell; and a busbar frame configured to support the busbar.

The busbar may include an insertion groove that is recessed in a direction away from the plurality of battery cells to correspond to a protruding shape of the guide part.

At least a portion of the guide part may be inserted into the insertion groove.

The insertion groove may extend in the height direction.

The insertion groove may include: a first portion having a tapered shape of which a width gradually decreases toward a lower end of the busbar frame in the height direction; and a second portion extending from a lower end of the first portion in the height direction and having a certain width.

The insertion space may include first and second insertion spaces defined in two sides of the plurality of battery cells along a protruding direction in which the guide part protrudes, wherein the fire-retardant assembly may be disposed in at least one of the first insertion space or second insertion space.

### BRIEF DESCRIPTION OF THE DRAWINGS

FIG. 1 is a view illustrating an example of a battery assembly according to the present disclosure.

FIG. 2 is an exploded view of the battery assembly according to the present disclosure.

FIG. 3 is a view of the battery assembly when viewed from the above according to the present disclosure.

FIG. 4 is a view illustrating an example in which a fire-retardant assembly is inserted into an insertion space when viewed from the above according to the present disclosure.

FIG. 5 is a view illustrating an example of the fire-retardant assembly according to the present disclosure.

FIG. 6 is a view illustrating one cross-section of the fire-retardant assembly illustrated in FIG. 5.

FIG. 7 is a view illustrating another cross-section of the fire-retardant assembly illustrated in FIG. 5.

FIG. 8 is a view illustrating another example of the fire-retardant assembly according to the present disclosure.

FIG. 9 is a view illustrating one cross-section of the fire-retardant assembly illustrated in FIG. 8.

FIG. 10 is an enlarged view illustrating a portion A of FIG. 4.

### DETAILED DESCRIPTION

Preferred embodiments of the present disclosure will be described below in more detail with reference to the accompanying drawings. A configuration or control method of the device described below is only for explaining embodiments of the present disclosure and is not intended to limit the scope of the present disclosure, and the same reference numbers used throughout the specification indicate the same components.

In addition, a battery assembly 200 according to the present disclosure is a concept that generally refers to a battery module or a battery pack. Thus, the battery assembly 200 according to the present disclosure may refer to not only a battery module but also a battery pack that accommodates battery cells without a battery assembly, such as a cell to pack (hereinafter, referred to as a “CTP”).

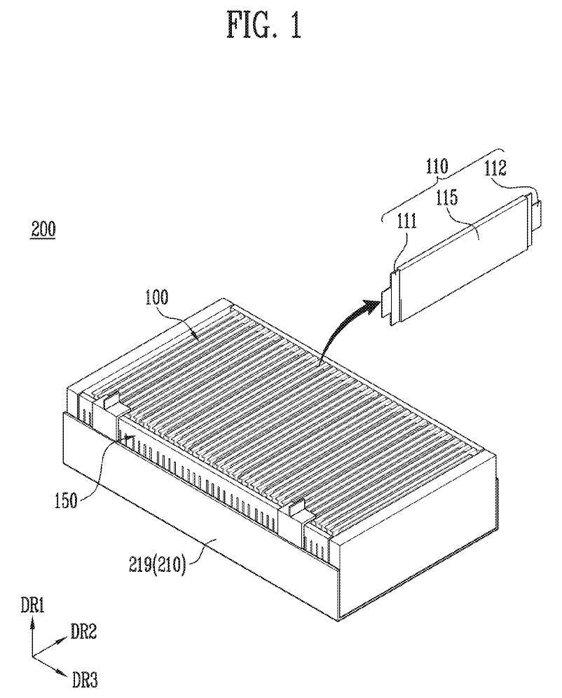

FIG. 1 is a view illustrating an example of the battery assembly 200 according to the present disclosure.

Referring to FIG. 1, the battery assembly 200 may include a plurality of battery cells 110 and an accommodation case 210 that accommodates the plurality of battery cells 110.

Each of the plurality of battery cells 110 may include a main body part 115 that generates or store electrical energy, and lead tab parts 111 and 112 protruding from the main body part 115 to the outside thereof. The main body part 115 may include an electrode assembly (not shown) that includes a positive electrode and a negative electrode therein to produce and store electrical energy.

In addition, the main body part 115 further includes an electrolyte (not shown) that is in contact with the electrode assembly. The electrolyte may be either a liquid or a solid. In addition, in the case in which the electrolyte is the liquid, the electrode assembly may further include a separator that separates the positive electrode from the negative electrode.

Referring to FIG. 1, the main body part 115 may have a pouch shape sealed with an exterior in the form of a film. FIG. 1 illustrates an example of a pouch-type battery cell 110, but is not limited thereto. Thus, the battery cell 110 may be of a prismatic shape or a cylindrical shape.

Lead tabs parts 111 and 112 may include a first lead tab 111 and a second lead tab 112 that protrude from the main body part 115 in a direction away from the main body part 115 at both side surfaces of the main body part 115. For example, the first lead tab part 111 may protrude from the main body part 115 in a direction opposite to a second direction DR2. In addition, the second lead tab part 112 may protrude from the main body part 115 in the second direction DR2. However, this is merely an example, and all both the tabs may be provided on one side surface of the lead tab parts 111 and 112.

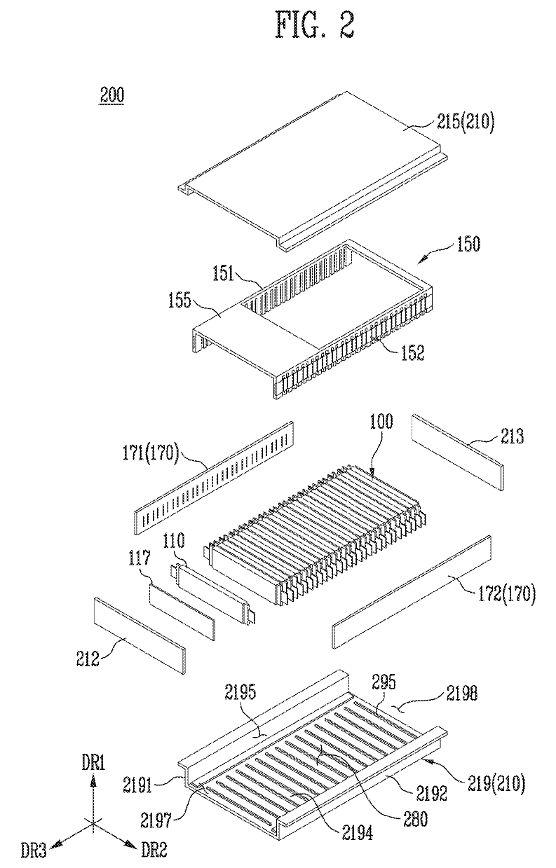

The accommodation case 210 may protect the plurality of battery cells 110 from external impacts such as vibration. The accommodation case 210 may include an accommodation body 219 that define a portion of an accommodation space 280 (see FIG. 2) for accommodating the plurality of battery cells 110 described below.

In addition, the battery assembly 200 may further include a busbar assembly 150 that electrically connects the plurality of battery cells 110 to the outside. The busbar assembly 150 may include a busbar 170 (see FIG. 2) that electrically connects the plurality of battery cells 110 so that a preset voltage is output. The form in which the busbar assembly 150 or a busbar 170 described below is assembled with the plurality of battery cells 110 is referred to as a cell stack 100.

FIG. 2 is an exploded view of the battery assembly 200 according to the present disclosure.

Referring to FIGS. 1 and 2, the accommodation case 210 may include an accommodation body 219 defining a portion of the accommodation space 280 for accommodating the plurality of battery cells 110, and an accommodation cover 215 coupled to the accommodation body 219 to define the accommodation space 280 together.

The plurality of battery cells 110 inside the accommodation body 219 may be disposed to overlap each other in a preset stacking direction (e.g., a third direction DR3).

The accommodation case 210 may further include an accommodation body 219 that accommodates the plurality of battery cells 110 through an opened top surface 2195, and an accommodation cover 215 coupled to the accommodation body 219 to close the opened top surface 2195.

Thus, the accommodation cover 215 may be coupled to the accommodation body 219 to define the top surface of the accommodation space 280 or the top surface of the accommodation case 210. That is, the accommodation cover 215 may be coupled to the accommodation body 219 to close the opened top surface 2195 and may define the accommodation space 280 together with the accommodation body 219.

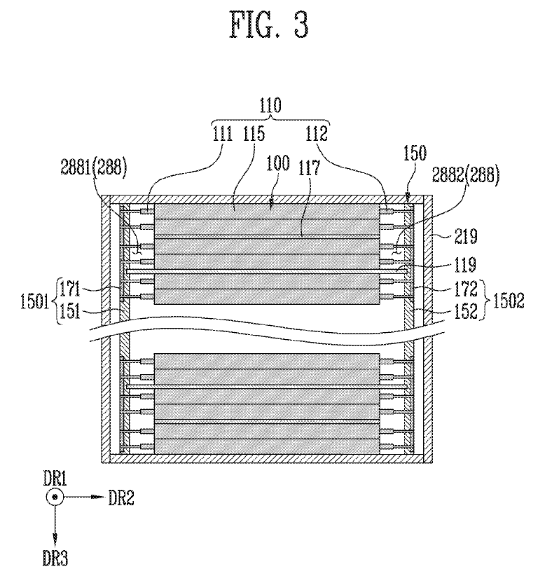

The accommodation space 280 may be defined inside the accommodation body 219 and may include a space for accommodating the cell stack 100. In addition, the accommodation space 280 may further include an insertion space 288 (see FIG. 3), which will be described below.

The accommodation body 219 may be provided in a shape of a channel with an opened upper portion or in a U-shape. For example, both side surfaces 2197 and 2198 of the accommodation body 219, which face each other along the third direction DR3, may also be opened.

The accommodation body 219 may include a body bottom surface 2194 that defines a bottom surface of the accommodation space 280, and body side surfaces 2191 and 2192 extending from the body bottom surface 2194 toward the accommodation cover 215 at edges (not shown) provided in parallel with each other in a stacking direction (e.g., the third direction DR3). A free end of each of the body side surfaces 2191 and 2192 may be bent to form a flange (not shown). As a result, it may be easy to be coupled to the accommodation cover 215.

Referring to FIGS. 1 and 2, a height of the accommodation body 219 may be smaller than a height of each of the plurality of battery cells 110. However, embodiments are not limited thereto. For example, the height of the accommodation body 219 may be equal to or greater than the height of each of the plurality of battery cells 110.

The cell stack 100 may further include a buffer member 117 or a thermal barrier member 119 (see FIG. 3) disposed between the plurality of battery cells 110.

The cell stack 100 may include at least one or more buffer members 117. Each of the buffer members 117 may be disposed between the battery cells 110. In addition, the buffer member 117 may be disposed between battery groups provided by grouping the plurality of battery cells 110. This may be equally applied to the thermal barrier member 119.

The cell stack 100 may include at least one or more thermal barrier members 119. The thermal barrier member 119 may serve as a thermal barrier to prevent flame or heat from propagating to an adjacent battery cell 110 in the event of thermal runaway of one battery cell 110.

The buffer member 117 and the thermal barrier member 119 may be provided as a single member to simultaneously perform a thermal barrier function and a buffering function.

The thermal barrier member 119 may also be provided in a multi-layer structure along a direction in which the plurality of battery cells 110 are stacked. For example, one layer in the multi-layer structure may be made of a flame-retardant material (or fire-retardant material). In addition, another layer in the multi-layer structure may serve to reduce a pressure exerted by other battery cells 110 when the battery cell 110 is swelled.

The plurality of battery cells 110 and the plurality of buffer members 117 may be provided at preset positions and then be stacked. For example, referring to FIG. 2, long edges of the plurality of battery cells 110 may be disposed in parallel with the second direction DR2. Thus, the plurality of battery cells 110 and the plurality of buffer members 117 may be disposed to overlap each other in the third direction DR3. This may be equally applied to the thermal barrier member 119.

The thermal barrier member 119 may be made of a fire-retardant (heat-resistant or flame-retardant) material. For example, the thermal barrier member 119 may include materials such as fire-retardant polymers or mica.

The battery assembly 200 may further include end plates 212 and 213 at both ends of the cell stack 100 in the stacking direction (e.g., the third direction DR3). The end plates 212 and 213 may be provided at both ends of the cell stack 100 or may be connected to both the side surfaces 2197 and 2198 of the accommodation body 219. The end plates 212 and 213 may be configured to prevent both the side surfaces of the cell stack 100 from being exposed to the outside.

The battery assembly 200 may include a busbar assembly 150. The busbar assembly 150 may include a busbar 170 electrically connected to the plurality of battery cells 110 and busbar frames 151, 152, and 155 that support the busbar 170. Here, the busbar frames 151, 152, and 155 may be electrically connected to the outside and thus may store (or charge) electrical energy in the plurality of battery cells 110 or supply (or discharge) electrical energy stored in the plurality of battery cells 110 to the outside.

The busbar assembly 150 may include a first busbar frame 151 and a second busbar frame 152, which extend in the stacking direction (e.g., the third direction DR3) of the plurality of battery cells 110 with the plurality of battery cells 110 therebetween.

In addition, the busbar assembly 150 may further include a support frame 155 disposed at one side of the busbar assembly 150 to connect the first busbar frame 151 to the second busbar frame 152.

FIG. 2 illustrates an example of the busbar assembly 150 in which the lead tab parts 111 and 112 are disposed in a direction opposite to the main body part 115, but is not limited thereto. For example, when the lead tabs parts 111 and 112 are disposed at one side of the main body part 115 to face the same direction, the busbar frames 151 and 152 may be disposed above the main body part 115 and electrically connected to the lead tabs parts 111 and 112.

The support frame 155 may serve to prevent deformation of the first busbar frame 151 and the second busbar frame 152 and to support the first busbar frame 151 and the second busbar frame 152. In addition, a portion of the electrical device for sensing and controlling the plurality of battery cells 110 may be disposed on the support frame 155.

Referring to FIG. 2, a shape of the busbar assembly 150 may be in the shape of a tunnel. In addition, a length of each of the first busbar frame 151 and the second busbar frame 152 in the stacking direction (e.g., the third direction DR3) may be longer than a length of the support frame 155. For example, the support frame 155 may be connected to the first busbar frame 151 and the second busbar frame 152 to cover upper portions of the plurality of battery cells 110. That is, the support frame 155 may cover not only a portion of the upper portions of the plurality of battery cells 110 but also all of the upper portions thereof.

The busbar 170 may include a first busbar 171 supported by the first busbar frame 151. The first busbar 171 may be electrically connected to the first lead tab part 111. The busbar 170 may include a second busbar 172 supported by the second busbar frame 152. The second busbar 172 may be electrically connected to the second lead tab part 112.

The first busbar 171 and the second busbar 172 may be disposed in a direction (e.g., the second direction DR2 and the opposite direction of the second direction DR2) that is farther away from the plurality of battery cells 110 than the first busbar frame 151 and the second busbar frame 152, respectively. The first busbar 171 and the second busbar 172 may be disposed closer to the body side surfaces 2191 and 2192 than the first busbar frame 151 and the second busbar frame 152. Thus, the first lead tab part 111 and the second lead tab part 112 may be inserted into slit holes (not shown) defined in the first busbar frame 151 and the second busbar frame 152, respectively, so as to be electrically connected to the first busbar 171 and the second busbar 172. However, embodiments are not limited thereto. For example, the first lead tab part 111 and the second lead tab part 112 may also be electrically connected to the first busbar 171 and the second busbar 172 in different manners.

The battery assembly 200 may further include a heat dissipation part 295. The heat dissipation part 295 may be disposed between the body bottom surface 2194 and the plurality of battery cells 110 to transfer heat generated in the plurality of battery cells 110 to the outside of the battery assembly 200. The heat dissipation part 295 may include an adhesive material having thermal conductivity. For example, the heat dissipation part 295 may include a heat dissipation adhesive. Thus, the plurality of battery cells 110 may adhere to the body bottom surface 2194 through the heat dissipation part 295. For this, the heat dissipation part 295 may be injected or applied on the body bottom surface 2194.

FIG. 3 is a view of the battery assembly when viewed from the above according to the present disclosure.

Referring to FIG. 3, the busbar assembly 150 may include a first busbar assembly 1501 and a second busbar assembly 1502.

The first busbar assembly 1501 may include a first busbar 171 electrically connected to the first lead tab part 111, and a first busbar frame 151 that supports the first busbar 171. The first busbar assembly 1501 may be electrically connected to the first lead tab part 111 and may serve to support the cell stack 100.

The second busbar assembly 1502 may further include a second busbar 172 electrically connected to the second lead tab part 112, and a second busbar frame 152 that supports the second busbar 172. The second busbar assembly 1502 may be electrically connected to the second lead tab part 112 and may function to support the cell stack 100 together with the first busbar assembly 1501.

Referring to FIG. 3, due to the electrical connection between the first and second lead tabs parts 111 and 112 and the busbar assembly 150, an empty space (hereinafter, referred to as an insertion space 288) may be defined between the plurality of battery cells 110 and the busbar assembly 150.

A portion of the accommodation space 280 (see FIG. 2) defined inside the accommodation case 210 (see FIG. 1) may be a space for accommodating the plurality of battery cells 110, and another portion of the accommodation space 280 may be a space for the insertion space 288.

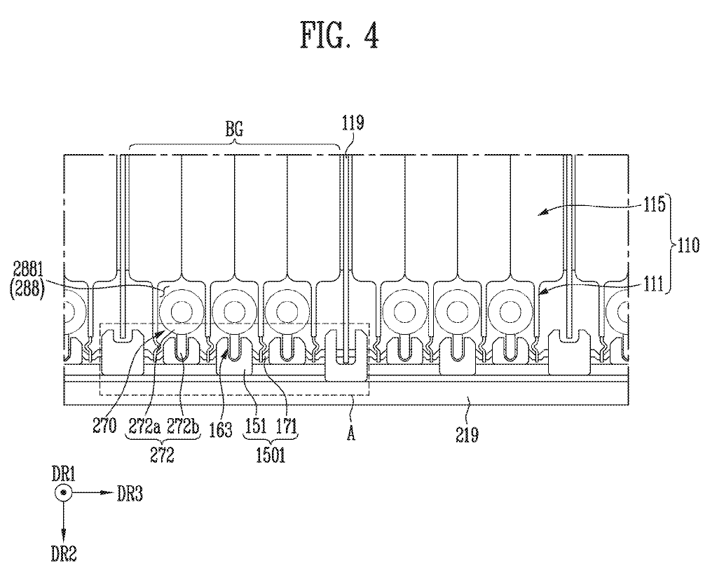

The insertion space 288 may be a space defined by each of the main body parts 115, the first and second lead tab parts 111 and 112, and the busbar 170. In general, when thermal runaway occurs in one of the plurality of battery cells 110, and an off-gas is generated, high-temperature heat may be propagated to an adjacent battery cell through the insertion space 288. In order to prevent such the thermal propagation, it is necessary to fill or cover the insertion space 288. For this, the battery assembly 200 may include a fire-retardant assembly 270 (see FIG. 4) disposed in the insertion space 288. Such the insertion spaces 288 may include a first insertion space 2881 and a second insertion space 2882, which are defined at two sides of the plurality of battery cells 110 along a protruding direction in which the guide parts 272b (see FIG. 4) protrude.

That is, the fire-retardant assembly 270 may be disposed in at least one of the first insertion space 2881 or the second insertion space 2882.

According to an embodiment, the battery assembly 200 may include the plurality of battery cells 110, the accommodation case 210 for accommodating the plurality of battery cells 110, the insertion space 288 defined between the plurality of battery cells 110 and the accommodation case 210, and the fire-retardant assembly 270 disposed in the insertion space 288.

The battery assembly 200 may further include a busbar assembly 150. The busbar assembly 150 may support the plurality of battery cells 110 and electrically connect the battery cells 110 to each other.

The buffer member 117 may be disposed between the plurality of battery cells 110. The buffer member 117 may be disposed between the plurality of battery cells 110. Alternatively, the buffer member 117 may be disposed between battery groups (not shown) provided by grouping the adjacent battery cells 110 in the preset number of groups. Although the length of the buffer member 117 in the second direction DR2 from the first busbar frame 151 to the second busbar frame 152 is illustrated as being equal to the length of the main body part 115, this is not limited thereto.

The thermal barrier member 119 may be disposed between the plurality of battery cells 110. The thermal barrier member 119 may be disposed between the respective battery cells 110. Alternatively, the thermal barrier member 119 may be disposed between the battery groups provided by grouping the adjacent battery cells 110 in the preset number of groups.

Here, the battery group may refer to a set of the battery cells obtained by grouping the adjacent battery cells 110 of the plurality of battery cells 110 in the preset number of groups. For example, the plurality of battery cells 110 may be grouped for a preset target voltage or target current. The plurality of grouped battery cells 110 may be connected in series or parallel using the busbar 170.

Referring to FIG. 3, although the thermal barrier member 119 and the buffer member 117 are illustrated as separate members, the thermal barrier member 119 and the buffer member 117 may also be provided as a single member as described above. This may also be referred to as the fire-retardant assembly (not shown). The fire-retardant assembly may be disposed between the plurality of battery cells 110 to perform a thermal barrier function during the thermal runaway and a pressure buffering function for a surface pressure of the battery cells during swelling.

A length of the thermal barrier member 119 in the second direction DR2 from the first busbar frame 151 to the second busbar frame 152 may be longer than the length of the main body part 115. More specifically, the thermal barrier member 119 may be in contact with the first busbar assembly 1501 and the second busbar assembly 1502. In this manner, when the thermal runaway occurs in an arbitrary battery cell 110, the heat or flame may be blocked or mitigated from spreading to other places by the thermal barrier member 119.

FIG. 4 is a view illustrating an example in which the fire-retardant assembly is inserted into the insertion space when viewed from the above according to the present disclosure.

Referring to FIGS. 3 and 4, the insertion space 288 may be defined between the plurality of battery cells 110 and the busbar assembly 150 (or the busbars 170 (see FIG. 2)). The insertion space 288 may be defined when each of the lead tab parts 111 and 112 is connected to the busbar assembly 150 (or the busbar 170).

The insertion space 288 may include a plurality of separation spaces that are separated by each of the lead tab parts 111 and 112. For example, each of the lead tab parts 111 and 112 may not isolate the plurality of separation spaces from each other in a separated state. That is, since a length of each of the lead tab parts 111 and 112 in a height direction (e.g., first direction DR1) of the accommodation case 210 (see FIG. 1) is smaller than a height of the accommodation space 280 (see FIG. 2), at least a portion of the accommodation space 280 may be separated along the height of the accommodation space 280.

That is, since the length of each of the lead tab parts 111 and 112 in the height direction of the accommodation case 210 is smaller than the length of each main body part 115, the plurality of insertion spaces 288 may be separated by each of the lead tab parts 111 and 112 or may communicate with each other.

For example, the plurality of first insertion spaces 2881 may be defined by the first lead tab part 111, and the plurality of first insertion spaces 2881 may communicate with each other. In addition, the plurality of first insertion spaces 2881 may be defined by the first busbar assembly 1501. The first busbar assembly 1501 may extend in the stacking direction (e.g., the third direction DR3) of the plurality of battery cells 110 and may be disposed at one side of the first insertion space 2881. The first busbar assembly 1501 may include a first busbar 171 electrically connected to the plurality of battery cells 110, and a first busbar frame 151 connected to the first busbar 171. In particular, the first busbar frame 151 may include an insertion groove 163 that is recessed in a direction away from the plurality of battery cells 110 (e.g., in the opposite direction to the second direction DR2) to correspond to the protruding shape of the guide part 272b.

A plurality of fire-retardant assemblies 270 may be disposed in the plurality of first insertion spaces 2881. Each of the fire-retardant assemblies 270 may include an exterior 272 that accommodates the fire-retardant member therein. The exterior 272 may include a housing part 272a and a guide part 272b disposed on a portion of one side surface of the housing part 272a to protrude from the housing part 272a. That is, the guide part 272b may be supported by the busbar assembly 150.

According to an embodiment, the fire-retardant assembly 270 may be inserted into the first busbar assembly 1501. At least a portion of the guide part 272b of the fire-retardant assembly 270 may be inserted into the insertion groove 163 of the first busbar frame 151. The fire-retardant assembly 270 may be supported by inserting at least a portion of the guide part 272b into the insertion groove 163 of the first busbar frame 151, which corresponds to the protruding shape of the guide part 272b. Thus, the assemblability of the battery assembly 200 may be improved.

Referring to FIGS. 3 and 4, the thermal barrier member 119 may be disposed between the plurality of battery cells 110. The thermal barrier member 119 may be disposed between the battery groups BG provided by grouping the plurality of battery cells 110. For example, the thermal barrier member 119 may be disposed in parallel with the plurality of battery cells 110 to extend to the first busbar assembly 1501. In detail, the thermal barrier member 119 may extend to the first busbar frame 151 and be inserted into the first busbar frame 151. In this case, the fire-retardant assembly 270 may not be inserted into the space in which the thermal barrier member 119 is inserted. This may prevent interference between the fire-retardant assembly 270 and the thermal barrier member 119.

For convenience of description, FIG. 4 illustrates the first busbar assembly 1501 as an example. However, the second busbar assembly 1502 may be configured in the same manner as the first busbar assembly 1501.

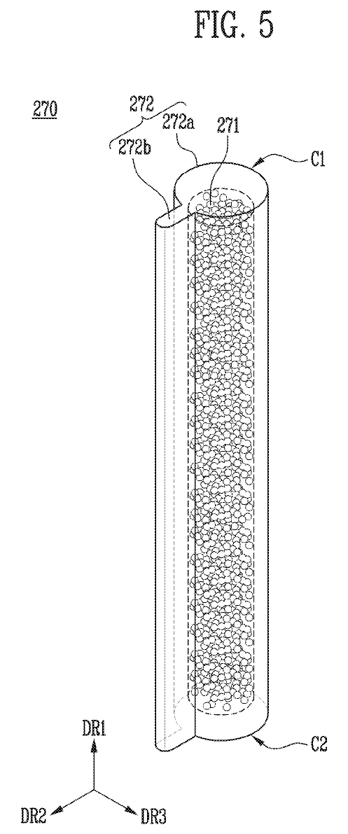

FIG. 5 is a view illustrating an example of the fire-retardant assembly according to the present disclosure.

Referring to FIG. 5, the fire-retardant assembly 270 may include a fire-retardant member 271 including a fire-retardant material and an exterior 272 accommodating the fire-retardant member 271 therein. The exterior 272 may extend in the height direction (e.g., first direction DR1) of the accommodation case 210 (see FIG. 1). Here, the height direction of the accommodation case 210 may be a direction perpendicular to the stacking direction of the plurality of battery cells 110.

The exterior 272 may include a housing part 272a having a pillar shape extending in the height direction of the accommodating case, and a guide part 272b disposed on a portion of one side surface of the housing part 272a to protrude from the housing part 272a.

The fire-retardant assembly 270 may have a circular pillar shape and may be provided in a shape coupled to a pillar shape protruding from a portion of one side surface. This is to guide the fire-retardant assembly 270 into the insertion space 288 so as to be supported by the busbar assembly. When the fire-retardant assembly 270 is inserted into the insertion space 288, the protruding shape of the fire-retardant assembly 270 may be inserted along the insertion groove 163 (see FIG. 4) of the busbar frame 151 (see FIG. 4) so as to be supported thereby. In FIG. 5, the shape of the housing part 272a may be exemplarily illustrated as a circular pillar shape, but is not limited thereto. For example, the shape of the housing part 272a may have various forms as long as the guide part 272b is disposed on a portion of one side surface thereof so that the guide part 272b is inserted into the insertion space 288.

The guide part 272b of the fire-retardant assembly 270 may extend in parallel with the housing part 272a. The guide part 272b of the fire-retardant assembly 270 may extend in a direction from one end C1 to the other end C2 of the housing part 272a. The guide part 272b may have a shape that extends from a portion of one side surface of the housing part 272a in the second direction DR2 to protrude. In detail, a width of the guide part 272b may be smaller than a diameter of the housing part 272a. The guide part 272b may be integrated with the housing part 272a so that an inner surface of the guide part 272b is connected.

As described above, the guide part 272b may guide the fire-retardant assembly 270 into the insertion space 288. For example, when the fire-retardant assembly 270 moves toward the insertion space 288, the guide part 272b may be inserted into the insertion space 288 along the inner surface of the insertion groove 163 of the busbar frame 151. Thus, the assemblability of the battery assembly 200 may be improved.

When considering a size of the insertion space 288, a diameter of the fire-retardant assembly 270 may be equal to or less than a thickness of one of the plurality of battery cells 110. A height of the fire-retardant assembly 270 may be greater than the diameter of the circular pillar-shaped fire-retardant assembly 270. This is to facilitate the insertion of the fire-retardant assembly 270 into the insertion space 288.

If it is assumed that each of the ends C1 and C2 of the fire-retardant assembly 270 has a chamfer shape that is tapered toward both ends, it may be easy for the fire-retardant assembly 270 to be inserted into the insertion space 288. However, due to the chamfer shape of each of the ends C1 and C2, there may be a loss in filling rate of the fire-retardant particles 271a. In consideration of this point, each of the ends C1 and C2 of the fire-retardant assembly 270 may have a plane perpendicular to the first direction DR1. For example, the fire-retardant assembly 270 may include the guide part 272b so that each of the ends is provided as a flat surface perpendicular to the first direction DR1 to improve the filling rate of the fire-retardant particles 271a.

The shapes of the ends C1 and C2 of the fire-retardant assembly 270 may be symmetrical to each other. This is done in order to improve convenience of assembling the battery assembly 200 by inserting the fire-retardant assembly 270 into the insertion space 288 without distinguishing upper and lower potions of the fire-retardant assembly 270 from each other.

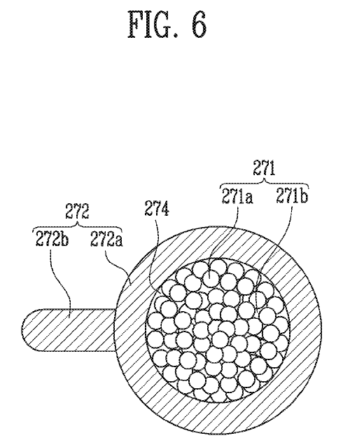

FIG. 6 is a view illustrating one cross-section of the fire-retardant assembly illustrated in FIG. 5.

Referring to FIG. 6, the fire-retardant assembly 270 may include a fire-retardant member 271 including a fire-retardant material and an exterior 272 accommodating the fire-retardant member 271 therein.

The exterior 272 may further include a fire-retardant space 274 defined by the exterior 272 to accommodate fire-retardant particles 271a and the fire-retardant member 271. Here, although the fire-retardant particles 271a are assumed to be spherical for convenience, a shape of each of the fire-retardant particles 271a is not limited to the spherical shape. For example, the fire-retardant particle 271a may have an amorphous shape. In addition, the fire-retardant particle 271a may not be limited to a single size, rather, may be in the form of a mixture of the fire-retardant particles 271a having various sizes. FIG. 6 illustrates the fire-retardant particles 271a that are exaggerated relative to their actual size for illustrative purposes.

Referring to FIG. 6, the fire-retardant member 271 may include the plurality of fire-retardant particles 271a. The fire-retardant particles 271a may be a solid filler provided in the form of solid particles, powder, granules, pellets, or beads. This is for preventing or mitigating propagation of flame or heat waves through the insertion space 288 in the event of thermal runaway of an arbitrary battery cell 110.

In addition, a size of each of the fire-retardant particles 271a may be equal to or less than the length or thickness of one battery cell 110 in the stacking direction. For example, the size of each of the fire-retardant particles 271a may be smaller than a distance between one lead tab part 111 or 112 and another lead tab part 111 or 112 adjacent to the one lead tab part 111 or 112. Thus, the fire-retardant particles 271a may be accommodated in the insertion space 288 (see FIG. 3) defined between one lead tab part 111 or 112 and another lead tab part 111 or 112. In detail, if the thickness of the battery cell 110 is about 15 mm, the size of each of the fire-retardant particles 271a may be about 15 mm or less.

The size of each of the fire-retardant particles 271a may be equal to or greater than the distance between one battery cell 110 of the plurality of battery cells 110 and another battery cell 110 adjacent to the one battery cell 110 in the stacking direction.

In addition, the fire-retardant particles 271a are not necessarily of the same size or material, but may be in the form of a mixture of the fire-retardant particles 271a having various sizes or materials.

Even if the thermal runaway occurs in the battery cell 110, the fire-retardant particles 271a may not be burned or melted, and the appearance of the fire-retardant particles 271a may remain while being changed with little change.

The fire-retardant member 271 or the fire-retardant particles 271a may be inserted into the fire-retardant space 284 defined by the housing part 272a of the exterior 272 to move freely therein. The fire-retardant member 271 or the fire-retardant particles 271a may be disposed in the fire-retardant space 284 so as to be in contact with each other without being separately restrained.

The fire-retardant member 271 or each of the fire-retardant particles 271a may be in a granular form. The fire-retardant member 271 or each of the fire-retardant particles 271a may be in the form of a solid filler. Thus, the fire-retardant assembly 270 may include a plurality of voids 271b defined between the fire-retardant members 271 or the fire-retardant particles 271a, which are in contact with each other. When the exterior 272 is melted, and the fire-retardant member 271 or the fire-retardant particles 271a, which are disposed in the fire-retardant space 284, are exposed to the accommodation space 280, the plurality of voids 271b may serve to mitigate heat transfer and disperse the flame along various paths rather than a straight line. In addition, in environments of a high temperature and high humidity during the thermal runaway, the plurality of voids 271b may serve as an electrically insulating member or a thermally insulating member.

Referring to FIG. 6, the exterior 272 may include a housing part 272a provided to surround the fire-retardant space 274, and a guide part 272b provided to protrude from one side surface of the housing part 272a. The guide part 272b may be integrated with the housing part 272a.

The housing part 272a may have a circular cross-sectional shape. The housing part 272a may include a circular hole in the circular cross-sectional shape. The circular hole may be an fire-retardant space 274 in which the fire-retardant member 271 is accommodated.

The guide part 272b may have an elliptical cross-sectional shape that protrudes from a portion of one side of the housing part 272a. However, embodiments are not limited thereto. For example, the guide part 272b may have a polygonal cross-sectional shape protruding from a portion of one side of the housing part 272a.

The guide part 272b may be integrated with the housing part 272a so that inner surfaces of the guide part 272b and the housing part 272a are connected to each other. However, the guide part 272b is provided to protrude from the housing part 272a and thus may be inserted into the insertion groove 163 (see FIG. 4) of the busbar frame 151 (see FIG. 4).

The exterior 272 may be made of a material that is capable of being melted at a temperature above an allowable temperature while accommodating the fire-retardant material 271. More specifically, the exterior 272 may be made of a heat-resistant (fire-retardant or flame-retardant) material that is not melted until reaching an allowable temperature. For example, the exterior 272 may be made of a polymer such as polypropylene (PP), polyethylene (PE), rubber, cellulose, or a resin. Alternatively, the exterior 272 may be made of a polymer in the form of foam.

The exterior 272 may enable the fire-retardant assembly 270 to be maintained in a certain shape regardless of the shape of the fire-retardant member 271. For example, when the fire-retardant member 271 is in a liquid state, the fire-retardant assembly 270 may be maintained in a preset three-dimensional shape by the exterior 272.

In addition, the exterior 272 may provide an effect of coding an outer surface of the fire-retardant assembly 270 to improve a moisture absorption or moisture resistance effect of the fire-retardant assembly 270.

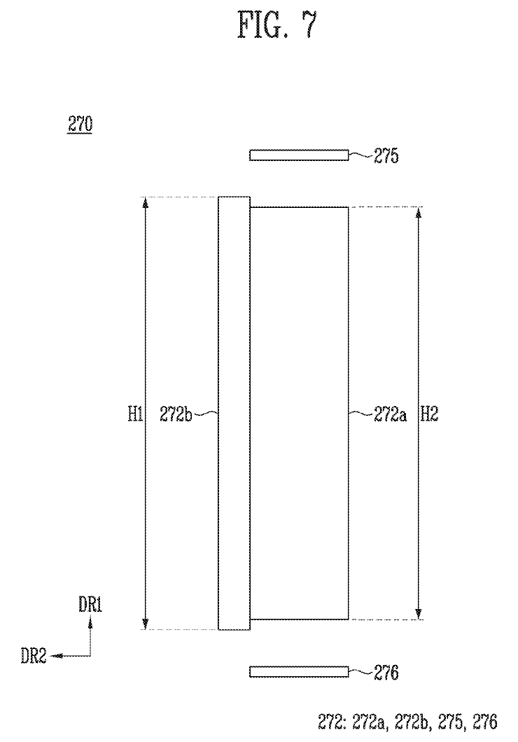

FIG. 7 is a view illustrating another cross-section of the fire-retardant assembly illustrated in FIG. 5.

Referring to FIGS. 5 and 7, the exterior 272 may include a housing part 272a, a first end 275 coupled to an upper side of the housing part 272a, a second end 276 coupled to a lower side of the housing part 272a, and a guide part 272b disposed on a portion of one side surface of the housing part 272a.

The housing part 272a may have a pillar shape extending in a height direction (e.g., first direction DR1) of the accommodation case 210 (see FIG. 1). The housing part 272a may have opened ends.

The exterior 272 may include a first end 275, which is coupled to the upper side of the housing part 272a to cover one end of the housing part 272a as one end of both the opened ends of the housing part 272a, and a second end 276, which is coupled to the lower side of the housing part 272a to cover the other end of the housing part 272a as the other end of both the opened ends of the housing part 272a. In this case, the first and second ends 275 and 276 may face each other.

Although FIG. 7 illustrates that the first and second ends 275 and 276 and the housing part 272a are separated from each other, an embodiment of the present disclosure is not limited thereto. For example, the first end 275 and the housing part 272a may be integrated with each other. Thereafter, the fire-retardant member 271 may be filled therein, and the second end 276 may be coupled to the housing part 272a to close the opened end of the housing part 272a. That is, the second end 276 may function as a lid.

As described above, the exterior 272 may include ends 275 and 276, which cover at least one opened end of the housing part 272a and each of which has planar one surface.

As illustrated in FIG. 5, a height H1 of the guide part 272b may be greater than a height H2 of the housing part 272a. In this case, each of the first and second ends 275 and 276 may have a circular cross-section corresponding to a cross-section of the housing part 272a. However, this is merely an example, and is not limited thereto. For example, the height H1 of the guide part 272b may be equal to or less than the height H2 of the housing part 272a.

In addition, the housing part 272a may further include a guide part 272b that protrudes outward in the shape of the circular pillar. The guide part 272b may be provided in a shape of an elliptical pillar protruding from one side surface of the housing part 272a and may extend between the first end 275 and the second end 276. The guide part 272b may improve the assemblability of the fire-retardant assembly 270 by guiding the insertion of the fire-retardant assembly 270.

The first and second ends 275 and 276 of the exterior 272 may include flat end faces perpendicular to the extension direction (e.g., the first direction DR1) of the housing part 272a. The first and second ends 275 and 276 may extend into the housing part 272a so as to angled at an angle of approximately 90 degrees with the housing part 272a. In particular, one surface of the second end 276 may be provided in a planar shape disposed on a bottom surface of the accommodation case 210. For example, the second end 276 may be provided in a planar shape that is perpendicular to one side surface of the housing part 272a and disposed in parallel with the body bottom surface 2194 (see FIG. 2), which is the bottom surface of the accommodation case 210. In this case, the fire-retardant assembly 270 may have a wider space than when at least one end of the exterior 272 has a tapered shape. Thus, the interior of the housing part 272a may be filled with more fire-retardant particles 271a.

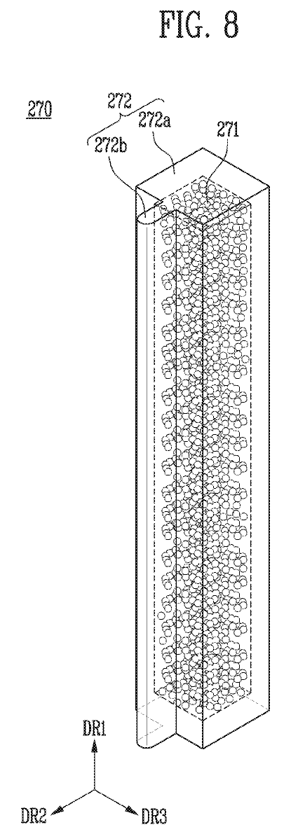

FIG. 8 is a view illustrating another example of the fire-retardant assembly according to the present disclosure.

Referring to FIG. 8, the fire-retardant assembly 270 may include a fire-retardant member 271 and an exterior 272 accommodating the fire-retardant member 271 therein. The exterior 272 may include a housing part 272a having a pillar shape extending in a first direction DR1, and a guide part 272b disposed on a portion of one side surface of the housing part 272a and protruding from the housing part 272a in a second direction DR2 perpendicular to the first direction DR1. The fire-retardant assembly 270 of FIG. 8 may be configured in the same manner as the fire-retardant assembly 270 of FIG. 5. Hereinafter, duplicated descriptions will be omitted.

The housing part 272a may have a rectangular parallelepiped shape. However, the shape of the housing part 272a is not limited thereto. For example, the housing part 272a may have a polygonal shape.

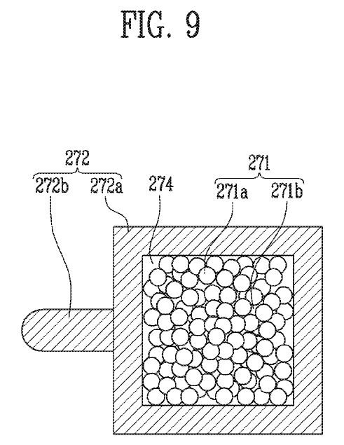

FIG. 9 is a view illustrating one cross-section of the fire-retardant assembly illustrated in FIG. 8.

The exterior 272 of FIG. 9 may further include a fire-retardant space 274 defined by the exterior 272 to accommodate fire-retardant particles 271a and the fire-retardant member 271. The exterior 272 and the fire-retardant particles 271a of FIG. 9 may be configured in the same manner as the exterior 272 and the fire-retardant particles 271a of FIG. 6. Hereinafter, duplicated descriptions will be omitted.

The housing part 272a may have a rectangular cross-sectional shape. The housing part 272amay include a rectangular hole within the interior having the rectangular cross-sectional shape. The rectangular hole may be a fire-retardant space 274 in which the fire-retardant member 271 is accommodated. However, embodiments are not limited thereto. For example, the housing part 272amay have a polygonal cross-sectional shape. The housing part 272amay include a polygonal hole inside the polygonal cross-sectional shape.

The guide part 272b may have an elliptical cross-sectional shape that protrudes from a portion of one of the side surfaces of the housing part 272a. For example, the guide part 272b may have a polygonal cross-sectional shape protruding from a portion of one side of the housing part 272a.

The guide part 272b may be integrated with the housing part 272a so that inner surfaces of the guide part 272b and the housing part 272a are connected to each other. However, the guide part 272b is provided to protrude from the housing part 272a and thus may be inserted into the insertion groove 163 (see FIG. 4) of the busbar frame 151 (see FIG. 4).

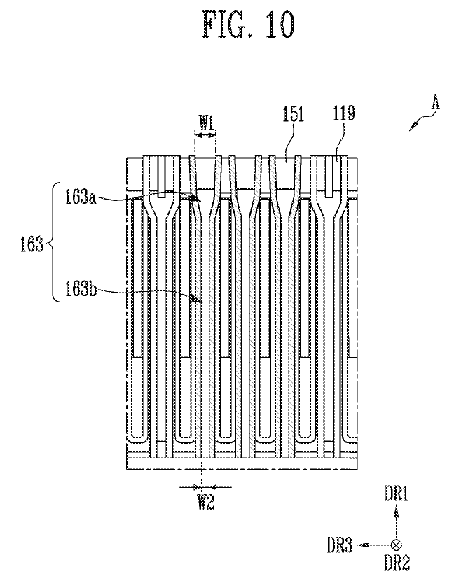

FIG. 10 is an enlarged view illustrating a portion A of FIG. 4.

Referring to FIG. 10, each of the busbar frames 151 and 152 (see FIG. 3) may include an insertion groove 163 (see FIG. 4) that is recessed in a direction away from the plurality of battery cells 110. The insertion groove 163 may extend in a height direction of the accommodating case 210 (see FIG. 1).

Hereinafter, for convenience of description, the first busbar frame 151 may be described as an example in FIG. 10. However, the second busbar frame 152 (see FIG. 3) may be configured in the same manner as the first busbar frame 151.

Referring to FIGS. 4 and 10, the first busbar frame 151 may be coupled to the guide part 272bof the fire-retardant assembly 270 to support the entire fire-retardant assembly 270. The first busbar frame 151 may include an insertion groove 163 corresponding to the protruding shape of the guide part 272b. That is, a portion of the guide part 272b of the fire-retardant assembly 270 may be inserted into the insertion groove 163 of the first busbar frame 151 so as to be supported. In addition, the insertion groove 163 of the first busbar frame 151 may guide movement of the guide part 272bwhen the fire-retardant assembly 270 is inserted. Thus, it may be easy to assemble the fire-retardant assembly 270 with the battery assembly 200.

The insertion groove 163 of the first busbar frame 151 may be recessed in a direction away from the plurality of battery cells 110 (e.g., the second direction). The insertion groove 163 may be recessed and may have a side surface facing each side surface of the guide part 272b.

The insertion groove 163 may extend in the height direction (e.g., the first direction DR1) of the accommodation case 210 (see FIG. 1) in parallel with the first busbar frame 151. The insertion groove 163 may include a first portion 163a having a tapered shape of which a width decreases as the insertion groove 163 extends downward along the height direction of the busbar frame, and a second portion 163b extending from a lower end of the first portion 163a along the height direction and having a certain width.

The first portion 163a may correspond to the upper end of the first busbar frame 151 and may have a tapered shape of which the width decreases as it goes toward the lower end of the first busbar frame 151. For example, the first portion 163a may have a first width W1 at the upper portion and may have a second width W2 that is narrower than the first width W1 at the lower portion connected to the second portion 163b.

The second portion 163b may correspond to the remaining portion of the first busbar frame 151, excluding the upper end of the first busbar frame 151 and may extend from the lower end of the first portion 163a and have a certain width. For example, the second portion 163b may have a certain second width W2.

As described above, since the insertion groove 163 is recessed to define side surfaces spaced apart from each other, a width between the side surfaces may be wider than each of the lower end of the first portion 163a and the second portion 163b at the upper end of the first portion 163a. Thus, the assembly of the guide part 272b of the fire-retardant assembly 270 with the first busbar frame 151 may be facilitated. For example, when the fire-retardant assembly 270 moves toward the insertion space 288, an upper portion of the first portion 163a of the insertion groove 163 may have a wide width to facilitate the insertion of the guide part 272b and thus also facilitates the assembly.

First, according to an aspect of the present disclosure, the heat resistance or the fire resistance may be improved to enhance the stability of the battery assembly.

Second, according to another aspect of the present disclosure, the high-temperature gas generated from the battery cell in which the thermal runaway occurs in the battery assembly, e.g., one or more battery cells provided inside the battery assembly may be prevented or mitigated from leaking toward the tab of the battery cell.

Third, according to another aspect of the present disclosure, the guide shape instead of the chamfer shape may be added to the existing fire-retardant assembly.

Fourth, according to another aspect of the present disclosure, the fire-retardant assembly may be easily disposed when the battery assembly is assembled.

Fifth, according to another aspect of the present disclosure, the filling rate of the fire-retardant assembly may be improved.

Sixth, according to another aspect of the present disclosure, the assemblability of the battery assembly may be improved.

The present disclosure may be modified in various forms, and thus the scope of the present disclosure is not limited to the above-described embodiments. Therefore, if the modified embodiment includes the components of the claims of this disclosure, it should be considered to fall within the scope of the claims of this disclosure.

What is claimed is:

1. A fire-retardant assembly comprising:
a fire-retardant member comprising a fire-retardant material; and
an exterior configured to accommodate the fire-retardant member therein,
wherein the exterior comprises:
a housing part having a pillar shape; and
a guide part disposed on a portion of one side surface of the housing part to have a shape protruding from the housing part.

2. The fire-retardant assembly of claim 1, wherein the guide part extends in a direction from one end to the other end of the housing part.

3. The fire-retardant assembly of claim 1, wherein the exterior comprises an end configured to cover at least one opened end of the housing part and having one surface having a planar shape.

4. The fire-retardant assembly of claim 1, wherein the exterior comprises:
a first end provided as one end of both opened ends of the housing part and coupled to an upper side of the housing part to cover the one end; and
a second end provided as the other end of both the opened ends of the housing part and coupled to a lower side of the housing part to cover the other end,
wherein the first and second ends are opposite to each other.

5. The fire-retardant assembly of claim 1, wherein the guide part is integrated with the housing part.

6. The fire-retardant assembly of claim 1, wherein the fire-retardant member comprises a plurality of fire-retardant particles.

7. The fire-retardant assembly of claim 6, wherein the plurality of fire-retardant particles are provided in a granular form.

8. A battery assembly comprising:
a plurality of battery cells;
an accommodation case configured to accommodate the plurality of battery cells;
an insertion space defined between the plurality of battery cells and the accommodation case; and
a fire-retardant assembly disposed in the insertion space,
wherein the fire-retardant assembly comprises:
a fire-retardant member comprising a fire-retardant material; and
an exterior configured to accommodate the fire-retardant member therein,
wherein the exterior comprises:
a housing part having a pillar shape extending in a height direction of the accommodation case; and
a guide part disposed on a portion of one side surface of the housing part to have a shape protruding from the housing part.

9. The battery assembly of claim 8, wherein the guide part extends in a direction from one end to the other end of the housing part.

10. The battery assembly of claim 8, wherein the exterior comprises an end configured to cover at least one opened end of the housing part and having one surface having a planar shape.

11. The battery assembly of claim 8, wherein the exterior comprises:
a first end provided as one end of both opened ends of the housing part and coupled to an upper side of the housing part to cover the one end; and
a second end provided as the other end of both the opened ends of the housing part and coupled to a lower side of the housing part to cover the other end,
wherein the first and second ends are opposite to each other.

12. The battery assembly of claim 11, wherein one surface of the second end is provided in a planar shape disposed on a bottom surface of the accommodation case.

13. The battery assembly of claim 8, wherein the guide part is integrated with the housing part.

14. The battery assembly of claim 8, further comprising a busbar assembly configured to support the plurality of battery cells and electrically connected to the plurality of battery cells,
wherein the guide part is supported by the busbar assembly.

15. The battery assembly of claim 14, wherein the busbar assembly comprises:
a busbar electrically connected to the plurality of battery cell; and
a busbar frame configured to support the busbar.

16. The battery assembly of claim 15, wherein the busbar comprises an insertion groove that is recessed in a direction away from the plurality of battery cells to correspond to a protruding shape of the guide part.

17. The battery assembly of claim 16, wherein at least a portion of the guide part is inserted into the insertion groove.

18. The battery assembly of claim 16, wherein the insertion groove extends in the height direction.

19. The battery assembly of claim 18, wherein the insertion groove comprises:
a first portion having a tapered shape of which a width gradually decreases toward a lower end of the busbar frame in the height direction; and
a second portion extending from a lower end of the first portion in the height direction and having a certain width.

20. The battery assembly of claim 8, wherein the insertion space comprises first and second insertion spaces defined in two sides of the plurality of battery cells along a protruding direction in which the guide part protrudes,
wherein the fire-retardant assembly is disposed in at least one of the first insertion space or second insertion space.
